(19) United States
(12) Patent Application Publication
(10) Pub. No.: US 2009/0204472 A1
(43) Pub. Date: Aug. 13, 2009

(54) Method and System for Managing Customer Relations

(76) Inventor: Ori Einhorn, Efrat (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/569,568

(22) PCT Filed: May 22, 2005
(86) PCT No.: PCT/IL05/00523

§ 371 Date: Jun. 17, 2008

(30) Foreign Application Priority Data
May 23, 2004 (IL) 162113

(51) Int. Cl. G06Q 30/00; G06F 17/30; G06F 17/40; G01C 21/00

(52) U.S. Cl. 705/10; 705/14; 705/16; 707/5; 701/213; 707/E17.017; 707/E17.018; 707/E17.044

(57) ABSTRACT

A method and system for managing customer relations by collaborating information for a group of various businesses with different or similar interests or that are complementary to one another. The businesses may even be in competition with one another. The system enables leveraging the overall information in a data collecting system, in order to increase profit and improve customer services, with an emphasis or the users' privacy. The system operates by dispensing, redeeming and documenting vouchers and information regarding total sales in real time via mobile communications.

### FIELD OF THE INVENTION

This invention relates generally to a method and system for managing customer relations for groups of businesses which may have different or similar interests or which are complementary to one another. The businesses can be in competition with one another. The system enables leveraging the overall information in a data collecting system, in order to increase profit and improve customer services, with an emphasis on the users' privacy. This can be accomplished by dispensing, redeeming and documenting vouchers and information regarding total sales in real time via mobile communications.

The method and system also is useful in managing customer relations for many small retail merchants in a shopping malls or a specific area, groups of service providers, groups of exhibitors in an exhibitions, etc.

### BACKGROUND OF THE INVENTION

While there are many large mass retail merchandise stores, such as Walmart™, Target™, Kmart™, etc., and large department stores, such as Macy's™, Bloomingdales™, Hechts™, etc., that sell a wide variety of consumer goods, many smaller retail merchants have problem to compete with them.

The same problem exists with other small businesses such as service providers and exhibitioners.

One method to deal with these problems is for small businesses to specialize and set themselves apart from the large mass retail merchandise stores or large department store. For example, in shopping malls across the country, there are many specialty stores that sell specific types of consumer goods, such as clothing, shoes, books, furniture, cookware, dishes, sporting goods, toys, etc. These establishments specialize in and deal with particular goods and are able to provide merchandize of a specialized nature as a means of attracting customers to their stores. Developing a marketing strategy that includes specialization often includes promoting products and services in a unique way to focus on the differences between the specialized products and other more general products. Many such retail establishments spend considerable time, money and effort creating concepts and images for branding purposes, and then conveying those concepts and images to consumers through advertising and other marketing methods to attract consumers to their stores.

Another method that some retail establishments use, in addition to specialization, is offering activities that are related to the products and services offered by the stores as a means of attracting new customers. For example, a cookware store might offer cooking classes, and an arts supply store might offer art classes. Stores have also begun to provide entertainment to attract customers. For example: McDonalds™has children's playgrounds to get kids to come to their restaurants. Rain Forest Cafe™ and Chuck E Cheese™ have animated characters and other entertainment to attract consumers. Sporting goods stores, such as Galyans™ have rock climbing walls, while others have indoor skiing facilities. Entire shopping malls can also provide activities and entertainment to attract customers. For example, movie theaters are commonly found in large shopping malls to attract customers to the malls. Some large malls even have built roller coaster rides and other attractions, while others have built-in playgrounds, and put on free concerts, exhibits, and galleries, etc. During Christmas time, malls typically have extensive decorations, Christmas trees, and Santa Claus, all designed to attract customers. In many cases, the entertainment is provided generally to attract people to the mall, but not necessarily to promote any particular goods or services of a particular retail merchant. Accordingly, consumers often simply come for the entertainment or activity, and end up not buying the products and services offered by the retail merchants that pay rent at the mall. Moreover, while some large retail stores that are not located in shopping malls are able to provide promotional activities in their own stores, many smaller retail merchants that occupy space in shopping malls often don't have the resources or the space to offer them on their own.

Thus methods are very expensive and not always bring the expected result.

There is thus a widely recognized need for, and it would be highly advantageous to have, a system that will enable a group of various businesses with different or similar interests or complementary to one another, to advance sales at a reasonable cost. The businesses may even be in competition with one another, by virtually unifying them into one big business, they will benefit from the CRM system that enables leveraging of the overall information in a data collecting system, in order to increase profit and improve customer services, with an emphasis on the users' privacy. The main component that will enable accomplishing the above is an electronic commerce enabling system, and in particular a system that provides voucher dispensing and redeeming.

For example, mobile network operators seek to provide more and more services through their existing mobile network. A commonly discussed application is mobile-commerce (hereinafter referred to as, “m-commerce”), which refers to the use of the mobile phone as a tool for undertaking financial transactions, replacing or working in conjunction with other payment solutions, such as credit cards. A specific example is the use in m-commerce of granting and redeeming vouchers, such as coupons, tickets, or proofs-of-purchase, via the mobile phone. However, voucher solutions that have been proposed so far require subscribers to master new and unfamiliar processes, or require modifications or new capabilities in the handsets or network. For instance, using Infrared interface on the handset requires the subscriber to learn how to align the handset with an IR interface positioned on the relevant Point Of Sale (POS) and transmit/receive a voucher message.

A problem with these solutions is that they depend on the service providers that are in competition with one another. Therefore, not all customers of those businesses can enjoy these benefits, thus missing the whole picture. Moreover, they are not able/allowed to share the information, and can't provide CRM solutions to the businesses. There is thus a need for a system that will enable cellular phone and other electronic commerce enabling systems, for example: internet, mobile telephone and wireless LAN, to cellular phones, PDA's, smart phones, mobile computers, notebook computers and personal computer users to utilize the basic commerce activities and transactions capability of their systems while keeping a high level of customer privacy. The customer should be able to initiate the documentation of each transaction without conditioning the receiving the benefit with documentation, yet provide fall CRM solution that fit the business requirements.

U.S. Patent Application No. 20040059593 proposes to solve this type of problem by creating a micro-environment to promote sales.

U.S. Patent Application No. 20030083934 discloses a system for dispensing and redeeming vouchers by voicemail.

### OBJECTS OF THE INVENTION

Accordingly several advantages and objects are obtained with the present inventive system.

It is an object of the invention to allow customers to have the ability to communicate with all means of communication in a simple way to notify about his location, desired connection, receiving vouchers that includes fully detailed and coded message, use of the benefit and sending an encoded message.

Another object is to allow a customer to initiate and determine documentation whenever desired (in a full privacy tract). Not in a fill privacy tract the customer will enjoy receiving vouchers based on location, time and special campaigns that depend on a time frame or/and according inventory.

Privacy is maintained by the systems response to customer instructions. The customer requests vouchers by sending a message to the system. The customer receives a voucher which may or may not be used. Should the voucher be used, the customer may opt to notify the system. In the absence of such notification the transaction will not be documented. Alternatively, the customer may send notification which will then be recorded. Furthermore the customer may make a transaction independently, and then notify the system which will then record and credit the transaction to the customer.

A customer may forgo part of his privacy but still maintain confidentiality. The system will then automatically identify and locate the customer using cell phone quadrant services or using scanners and will transmit vouchers without regard of his/her location. Messages will be transmitted automatically at Point of Sale/Transaction in Real Time without any action from the customer.

A further object is to allow customers to join groups of customers for example: a family, a company, a body of students, workers' committee etc. As a group they will get benefits within the definition of the customer reimbursement, for example: first comes first served or an equal share via Entity Builder Application (EBA).

A still further object is to allow a business to enjoy CRM advanced systems like the systems that exist in big companies with analytic CRM like the systems that: Siebel, Vantive, Clarify, Oracle CRM, SAP developed. Unlike, Microsoft Business Solutions CRM. Best Software consists pore capabilities especially CRM analytics.

Yet another object is to enable production of reports that compare one's business to a business in the same category including trends and time series. The method of sending vouchers for all businesses in the same category that include different: coupons, benefits, discounts and advertising for each and every business in the same category. The vouchers are produced by a product of sophisticated data mining and statistics algorithms, that are limited by rules and scenarios allows collaborated information between businesses in highly equal degree and a high confidence from the businesses.

The system is based on Data Warehouse with a deep history data that contains all information from all businesses. This enables implementation in Real Time of Statistical and data mining algorithms in order to implement applications such as “cross sale” and “up sale” also between businesses to fit the customer's needs and chum prediction for specific business, business category and all businesses.

Businesses will enjoy CRM advanced systems like the systems that exist in big companies with analytic CRM with advanced applications, as:
Campaign Management
This includes enhanced capabilities such as; stop and open campaigns in Real Time, according to number of customers and/or existing inventory at this moment. Including the regular capabilities that exist in: E.piphany Campaign Management, part of the E.piphany E.6™.
Customer Profile Generator
Club Application
This includes capabilities that exist in: Club Management Software from iFitness solutions.
Customer Retention and Loyalty Application
Including capabilities that exist in: MINvision Churn solution.
Credit Management Application
Report Generator
This includes real time dashboards, reporting and business intelligence.

With this system a high Privacy policy is maintained by giving the customers the ability to decide in each and every transaction whether it will be documented or not (in a full privacy tract), for example: when the customer receives a voucher which may or may not be used. Should the voucher be used, the customer may opt to notify the system—it will be documented. If the customer decides to use the voucher and not to notify—In the absence notification the transaction will not be documented.

Vouchers are sent (in a fall privacy tract) only after customer applies for it. Unlike the other tracts (not in a full privacy tract) the customer will enjoy receiving vouchers based on location, time and special campaigns that depend on a time frame or/and according inventory. All vouchers are produced by the analytical engine that executes complex analytical models over operational processes in real-time based on real time and historical data that fit the customer's needs based on his transaction or the behavior of the segment the customer belongs to.

The algorithms are based on data such as: previous purchasing, voucher usage in a level of group of businesses, time, day of the weak, time between purchasing, seasonality of the customer and/or the segment the customer belongs to.

The voucher will be sent to the customer only if the probability is medium in order to increase sales. In case there is a need to increase loyalty a high probability voucher will be sent. Thus the vouchers are based on customer value degree of loyalty and rewarding the customers' cooperation.

Interactive real time vouchers can change according to time and use all the while updating the customer for example: the first one hundred customers get 50% discount. The next one hundred customers get 40% discount and so on. According to customers request he will be given an update.

By dispensing, redeeming and documenting of vouchers and information regarding total sales in real time via mobile communications the system enhances capabilities such as: stop and open campaigns in Real Time, according to number of customers and/or existing inventory at this moment.

### SUMMARY OF THE INVENTION

In view of the limitations now present in the prior art, the present invention provides a new and useful method and system for managing customer relations for groups of various businesses with different or similar interests or that are complementary to one another. The businesses may even be in competition with one another. The system enables leveraging of the overall information in a data collecting system, in order to increase profit and improve customer services, with an emphasis on the users' privacy. This can be accomplished by dispensing, redeeming and documenting of vouchers and information regarding total sales in real time via mobile communications. The system is simpler in construction, more universally usable and more versatile in operation than known systems, and is not apparent, obvious, or suggested, either directly or indirectly by the prior art.

The system of the present invention comprises:

A. a MS (Messaging System) for receiving and transmitting messages.

B. an ACS (Active CRM Server).

C. a POCU (Point Of Contact Unit).

The messaging system A includes subsystems:

1.1 Subsystem RS (Registration System).

This registers and records customer information, primary demographic data and preferences via IVR, filing out forms through the internet or mobile communications, including questionnaires.

The subsystem enables building groups of customers via the entity builder.

1.2 Subsystem LTR (Location Trigger Receiver)

This subsystem receives the indication from the various systems (Location Trigger Input) and sends the information to the ACS (Active CRM Server)

1.3 Subsystem MD (Message Distributor)

This subsystem receives personal benefits, coupons, advertising and discounts for the specific customer from ACS, encodes the messages for the specific customer and sends the detailed information and the code to the customer in the various communication I/O.

Encoding includes the customer identification number, the expiration date and the POC. In addition to the personal benefits, coupons, advertising and discounts information codes.

1.4 Subsystem FU (Feedback Unit)

The subsystem receives from the customer by Communication I/O the code that was produced by the POCU (Point Of Contact Unit) or directly from the POCU via the LAN.

The code is deciphered and sent to the ACS.

The Active CRM server B, includes:

2.1 OA (Operational Applications), comprising:

2.1.1 CMA (Campaign Management Application)

This enables
analysis of data and the opportunity to identify the need to analyze data and therefore enables the opportunity to change behaviors,
customer Targeting will define the campaign population,
Campaign Planning and Segment customers to be assigned value propositions,
Campaign Execution Schedule's the campaign and generates the files,
closed loop analysis that captures and analyze the response and purchase data.

2.1.2 EBA (Entity Builder Application)

This enables the customer to join group of customers for example: A family, company, a body of students, workers' committee and so on . . . as a group they will get benefits within the definition of the customer reimbursement, for example: first comes first served or an equal share.

2.1.3 CPG (Customer Profile Generator

In the RSG the businesses or the business analysist formulates the rules or/and scenarios based on the transaction and aggregation data (parameters) that has been gathered over different time spans and by different categories. In order to define the rules or/and scenarios. We need to define the aggregation of data in the CPG. If the system configurations include DDS, the parameters update according to previous transaction history, otherwise it will update from the present. The parameters are stored in SDS.

2.1.4 RSG (Rules and Scenario Generator)

RSG enables the businesses or the business analysist to define complex analytical functions comprising: triggers, rules, patterns, hypotheses, models, stats and more. Thus facilitating the system to build a target group of people and to define sophisticated campaigns that serve CMA.

2.1.5 CA (Club Application)

Club membership consists of customers that are interested in more intense communication with the businesses. Calculating individual customers' high value based on a range of purchasing that makes the marketing effort worthwhile and could be set in the different club categories, for example: Platinum, Gold, and Silver. Additionally to the regular membership benefits such as advertising, benefits, accumulation of benefit points there are Special campaigns that can be run for example: Interactive real time vouchers that change according to time and use all the wile updating the customer for example: the first one hundred customers get 50% discount. The next one hundred customers get 40% discount and so on. According to customers request the customer will be given an update. The Club Members can enjoy the automatic Location Trigger Service.

2.1.6. CLA (Customer retention and Loyalty Application)

Reaping all the benefits of the leading statistical analysis and data mining software to predict Churn probabilities. For customers of high value with high churn risk we proactively promote offering personalized benefits, by using ‘below the line’ campaigns in order to reduce churn rates.

Churn includes in our perspective a decrease in frequencies of purchase/visiting or even a decrease in one category even if there is an increase in other categories

2.1.7. CMA (Credit Management Application)

Management of benefits for example: If the customer purchases two produces from a series at the next time he will get a discount of X amount.

Businesses that don't give money back for returns we could manage the balance and deduction between businesses.

2.2 DDS (Detailed Data Storage)

The DDS is optional to those whom are interested in saving elaborate data in order to analyze the data without predefining the parameters. In the DDS all data is stored at the level of a single transaction for example: Documentation of the vouchers that have been sent, documentation of all the messages the customer sent back, documentation of changes and more . . .

2.3 SDS (Summaries Data Storage)

At SDS all aggregated data is stored for example: Customer profile, summarized data of a business or group of businesses throughout different time spans, data that the DMSE needs to use in building the model and to run it in real time.

2.4 DMSE (DM/Stat Engine)

Reaping all the benefits of the leading statistical analysis and data mining software for example: One of the algorithms that were modified by us to produce attractive benefits is a data mining algorithm called: Multidimensional Association rules-Apriori that has been fitted to this specific purpose. The main dimensions are: assortment of businesses/shops, a single business, and the total sum of purchases, time of purchases and the time between purchasing.

The analytical engine makes use of “fairness” algorithms and rules when distributing each stores' promotions. Following are some examples of factors considered: store's promotion quantity, real-time redemption rates, store's contribution to the process, etc.

2.5 RG (Reporting Generator)

The businesses can produce reports and other information by tools like Business Objects.

The Point of Contact Unit, C includes:

3.1 DPU (Deciphered Legitimate Present Unit)

The client gives the vender the number of the voucher. Then the vender will type the voucher code into the system. The system deciphers the code into the following: Cell phone number, date and expiration, a group of vendors, a specific vendor, the code of product or products, benefits and discounts. The system runs the information through several validity checks for example: is the deciphering legitimate, weather the date is expired and is this right vender.

3.2 CPU (Code Production Unit)

The client receives an encrypted code comprising: cell phone number, date of purchase, vendors' code, total sale and an indication to use a voucher.

Accordingly the client will send the code to the system. The system will then decrypt the code and update the database.

3.3 OCDU (Optional Code Dispensing Unit)

This sends code through the regular mobile network directly to FU. As long as the customers' privacy isn't the main consideration.

3.4 EOA (Enables access to Operational Applications)

3.5 ERG (Enables access to Report Generator)

This system requires Input/Output means, which can be:

1. Communication I/O (Input/Output) with the Customer
the system receives an input and sends an output of messages in all available communication systems, for example: internet, mobile telephone and wireless LAN, to cellular phones, PDA's, smart phones, mobile computers, notebook computers and personal computers. The messages may be in the form of a voice, text or multimedia message.

2. Location Trigger Input, from:
2.1 Cellular companies.
2.2 Local system of scanners.
2.3 Receiving requests from the customer by Communication I/O.

### BRIEF DESCRIPTION OF THE DRAWINGS

The present invention will be understood and appreciated from the following detailed description, taken in conjunction with the following drawings, in which:

FIG. 1. is a block diagram of the Physical Architecture of the system of this invention.

FIG. 2. is a flow diagram of a Voucher Redeeming Process according to the invention.

FIG. 3. is a system flow diagram according to the present invention.

### DETAILED DESCRIPTION OF THE INVENTION

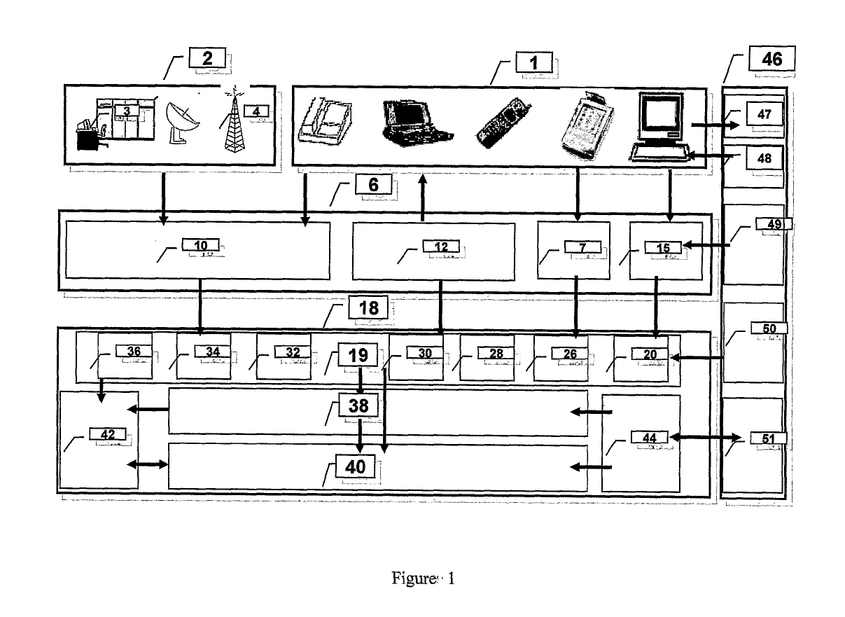

Referring now to FIG. 1, this is a block diagram which illustrates the Physical Architecture of the system and method for managing customer relations for a group of businesses via mobile communication means, according to the present invention.

1. Communication I/O (Input Output) with the customer: the system receives an input and sends an output of messages in all available communication systems, for example: internet, mobile telephone and wireless LAN, to cellular phones, PDA's, smart phones, mobile computers, notebook computers and personal computers. The messages may be in the form of a voice, text or multimedia message.

2. Location Trigger Input from:

3. Cellular companies.

4. Local system of scanners.

5. Receiving requests from the customer by Communication I/O.

6. MS (Messaging System) receiving and transmitting messages comprising:

7. Subsystem RS (Registration System).

8. The subsystem registers and records customer information, primary demographic data and preferences via IVR, filing out forms through the internet or mobile communications, including questionnaires.

9. The subsystem enable to build group of customer via the entity builder

10. Subsystem LTR (Location Trigger Receiver)

11. The subsystem receives the indication from the various systems (Location Trigger Input) and sends the information to the ACS (Active CRM Server)

12. Subsystem MD (Message Distributor)

13. The subsystem receives personal benefits, coupons, advertising and discounts for the specific customer from ACS. Encodes the messages for the specific customer and sends the detailed information and the code to the customer in the various Communication I/O.

14. Encoding includes the customer identification number, the expiration date and the POC. In addition to the personal benefits, coupons, advertising and discounts information codes.

15. Subsystem FU (Feedback Unit)

16. The subsystem receives from the customer by Communication I/O receives the code that was produced by the POCU (Point Of Contact Unit) or directly from the POCU via the LAN.

17. The code is deciphered and sent to the ACS.

18. ACS (Active CRM Server) comprising:

19. OA (Operational Applications) comprising:

20. CMA (Campaign Management Application)

21. Enables the analysis of data and the opportunity to identify the need to analyze data and therefore enables the opportunity to change behaviors.

22. Customer Targeting will define the campaign population.

23. Will enable Campaign Planning and Segment customers to be assigned value propositions.

24. Campaign Execution Schedule's the campaign and generates the files.

25. Closed loop analysis that captures and analyze the response and purchase data.

26. EBA (Entity Builder Application)

27. The EBA enables the customer to join group of customers for example: A family, company, a body of students, workers' committee and so on . . . as a group they will get benefits within the definition of the customer reimbursement, for example: first comes first served or an equal share.

28. CPG (Customer Profile Generator

29. In the RSG the businesses or the business analysis formulates the rules or/and scenarios based on the transaction and aggregation data (parameters) that has been gathered over different time spans and by different categories. In order to define the rules or/and scenarios. We need to define the aggregation of data in the CPG. If the system configurations include DDS, the parameters update according to previous transaction history, otherwise it will update from the present. The parameters are stored in SDS.

30. RSG (Rules and Scenario Generator)

31. RSG enables the businesses or the business analysis to define complex analytical functions comprising: triggers, rules, patterns, hypotheses, models, stats and more. Thus facilitating the system to build a target group of people and to define sophisticated campaigns that serve CMA.

32. CA (Club Application)

33. Club membership consists of customers that are interested in more intense communication with the businesses. Calculating individual customers' high value based on a range of purchasing that makes the marketing effort worthwhile and could be set in the different club categories, for example: Platinum, Gold, and Silver. Additionally to the regular membership benefits such as advertising, benefits, accumulation of benefit points there are Special campaigns that can be run for example: Interactive real time vouchers that change according to time and use all the wile updating the customer for example: the first one hundred customers get 50% discount. The next one hundred customers get 40% discount and so on. According to customers request the customer will be given an update. The Club Members can enjoy the automatic Location Trigger Service.

34. CLA (Customer retention and Loyalty Application)

35. Reaping all the benefits of the leading statistical analysis and data mining software to predict Churn probabilities. For customers of high value with high chum risk we proactively promote offering personalized benefits, by using ‘below the line’ campaigns in order to reduce churn rates.

Churn includes in our perspective a decrease in frequencies of purchase/visiting or even a decrease in one category even if there is an increase in other categories

36. CMA (Credit Management Application

37. Management of benefits for example: If the customer purchases two produces from a series at the next time he will get a discount of X amount. Businesses that don't give money back for returns we could manage the balance and deduction between businesses.

38. DDS (Detailed Data Storage)

39. The DDS is optional to those whom are interested in saving elaborate data in order to analyze the data without predefining the parameters. In the DDS all data is stored at the level of a single transaction for example: Documentation of the vouchers that have been sent, documentation of all the messages the customer sent back, documentation of changes and more . . .

40. SDS (Summaries Data Storage)

41. At SDS all aggregated data is stored for example: Customer profile, summarized data of a business or group of businesses throughout different time spans, data that the DMSE needs to use in building the model and to run it in real time.

42. DMSE (DM/Stat Engine)

43. Reaping all the benefits of the leading statistical analysis and data mining software for example: One of the algorithms that were modified by us to produce attractive benefits is a data mining algorithm called: Multidimensional Association rules-Apriori that has been fitted to this specific purpose. The main dimensions are: assortment of businesses/shops, a single business, and the total sum of purchases, time of purchases and the time between purchasing.

44. RG (Reporting Generator)

45. The businesses can produce reports and other information by tools like Business Objects.

46. POCU (Point Of Contact Unit) comprising:

47. DPU (Deciphered Legitimate Present Unit)

The client gives the vender the number of the voucher. Then the vender will type the voucher code into the system. The system deciphers the code into the following: Cell phone number, date and expiration, a group of vendors, a specific vendor, the code of product or products, benefits and discounts. The system runs the information through several validity checks for example: is the deciphering legitimate, weather the date is expired and is this right vender.

48. CPU (Code Production Unit)

The client receives an encrypted code comprising: cell phone number, date of purchase, vendors' code, total sale and an indication to use a voucher.

Accordingly the client will send the code to the system. The system will then decrypt the code and update the database.

49. OCDU (Optional Code Dispensing Unit).

Sends code through the regular mobile network directly to FU. As long as the customers' privacy isn't the main consideration.

50. EOA (Enables access to Operational Applications)

51. ERG (Enables access to Report Generator)

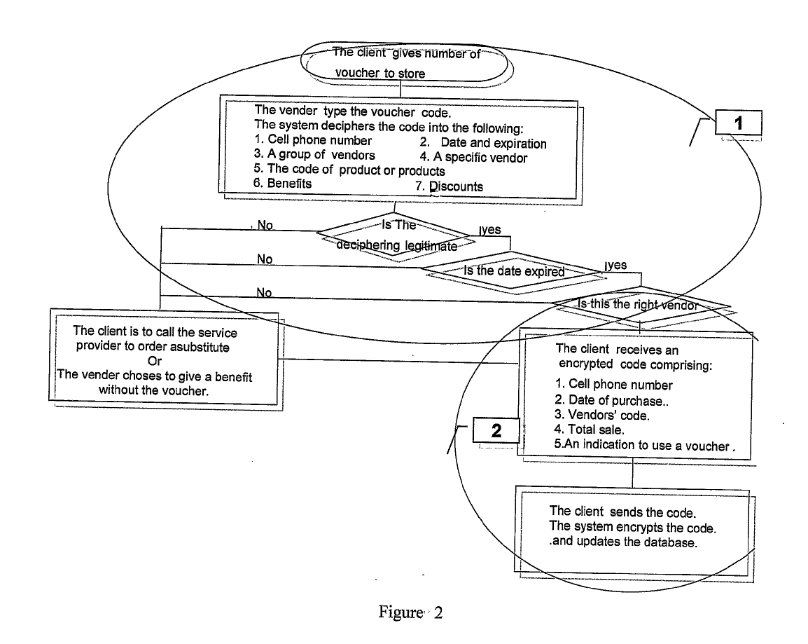

Referring now to FIG. 2, this is a flow diagram that illustrates the voucher redeeming process according to the present invention.

1. DPU (Deciphered Legitimate Present Unit)

The client gives the vender the number of the voucher. Then the vender will type the voucher code into the system. The system deciphers the code into the following: Cell phone number, date and expiration, a group of vendors, a specific vendor, the code of product or products, benefits and discounts. The system runs the information through several validity checks for example: is the deciphering legitimate, weather the date is expired and is this right vender.

2. CPU (Code Production Unit)

The client receives an encrypted code comprising: cell phone number, date of purchase, vendors' code, total sale and an indication to use a voucher. Accordingly the client will send the code to the system. The system will then decrypt the code and update the database.

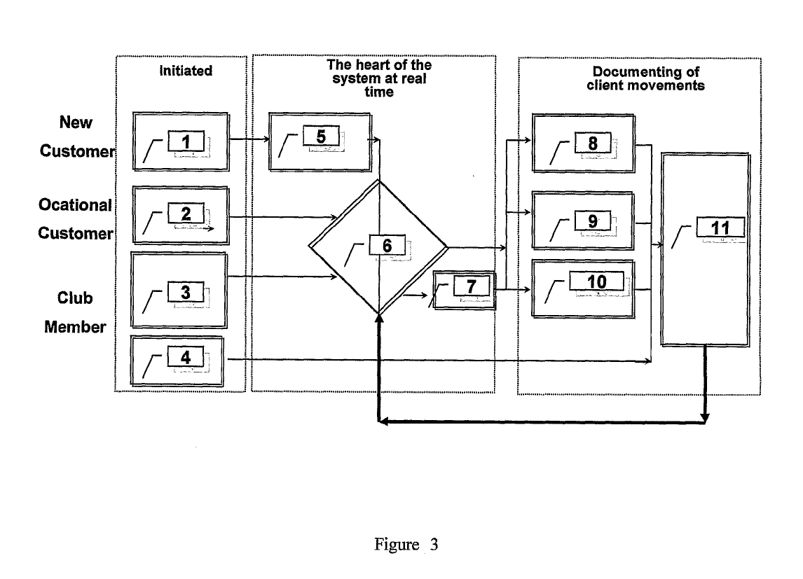

FIG. 3 is a system work flow diagram that illustrates the method and system for managing customer relations for a group of businesses via mobile communication means, according to the present invention.

The system treats differently three types of customer:

New customer: the customer initiates first contact.

Club customer: of customers that are interested in more intense communication with the businesses. Calculating individual customers' high value based on a range of purchasing that makes the marketing effort worthwhile and could be set in the different club categories

Occasional customer: All customers that don't fit within the previous customers. Numbers 1, 5, 8 refers to New customer 3, 4, 10 refers to Club customers 2, 9 refers to Occasional customer 6, 7, 11 refers to all.

1. Customer initiated contact of service provider.

The contact can be by calling/sending SMS to a special number or filling an application via the internet/wireless LAN or after filling a questioner.

2. Customer contacts service provider.

The contact can be by calling/sending SMS to a special number or via the internet/wireless LAN.

3. Customer contacts service provider or the system locates customer.

The same as 2 and after special request by Location Trigger Input from Cellular companies or Local system of scanners.

4. Customer purchases and sends purchase voucher to service provider via Communication I/O (see FIG. 1 remark 1)

5. Customer lists preferences to the subsystem that registers and records customer information, primary demographic data and preferences via IVR, filing out forms through the internet or mobile communications, including questionnaires. Subsystem RS (see FIG. 1 remark 7).

6. The customer gets vouchers (that are produced in real time): coupons, benefits and discounts, Based upon present or past purchases that the subsystem receives personal benefits, coupons, advertising and discounts for the specific customer from ACS (see FIG. 1 remark 18). Encodes the messages for the specific customer and sends the detailed information and the code to the customer in the various Communication I/O (see FIG. 1 remark 1).

7. System initiates contact due to an indication from Location Trigger from Cellular companies or Local system of scanners (see FIG. 1 remark 10,11). 8,9,10 Customer uses vouchers.

11. The subsystem receives (see FIG. 1 remark 15) from the customer by Communication I/O (see FIG. 1 remark 1) receives the code that was produced by the POCU (Point Of Contact Unit) (see FIG. 1 remark 46) or directly from the POCU via the LAN. The system documents the transactions in the DDS(see FIG. 1 remark 38) or/and SDS (see FIG. 1 remark 40).

It will be appreciated by persons skilled in the art that the present invention is not limited to what has been particularly shown and described hereinabove. Rather, the scope of the present invention is defined only by the claims that follow:

1-14. (canceled)

15. A method of managing customer relations and promoting sales at a point of sale (POS), comprising:
a. analyzing data concerning former purchasing behavior stored in an adaptive data warehouse,
b. determining one or more vouchers to be dispensed to said customer; and,
c. dispensing one or more vouchers to said customer; each of said vouchers comprising financial data and merchandise-related data obtained as a result of said analysis.

16. The method according to claim 15, wherein said message is received from said customer's mobile communicating means, comprising further identifying said customer in said POS by tracking the present location of said communication device, especially by using GPS, triangulation or any other locating means.

17. The method according to claim 15, comprising further ranking said vouchers, thus determining the order by which said vouchers are dispensed.

18. The method according to claim 17, wherein said ranking is at least partially a function of statistical analysis.

19. The method according to claim 15, comprising further determining the number of vouchers dispensed to one or more customers, customers groups or POSs, according to said data regarding former purchasing behavior.

20. The method according to claim 15, wherein said mobile communicating means is selected from a group including mobile phones, laptop, smart phone, PDA, cellular phone, notebook computer and personal computer.

21. The method according to claim 15, wherein said POS is selected from a mall, store, business, street, shopping center, regions inside a department store, city, entertainment center or any combination thereof.

22. The method according to claim 15, wherein said financial data refers to sum of money, payment terms, discounts, or any combination thereof.

23. The method according to claim 15, wherein said purchasing behavior is selected from a group comprising the customer's behavior, customer's behavior in said POS, customer's behavior at a given time, sum of money spent in one or more business, sum of money spent on one or more fields such as clothing, food, entertainment and others, probability of purchase of one or more customers in one or more businesses obtained as a result of statistical analysis or any combination thereof.

24. The method according to claim 15, comprising further commencing and/or terminating a campaign, based on the number and/or characteristics of the customers requesting one or more vouchers.

25. The method according to claim 15 comprising further receiving the customer's decision on whether to document the receipt of said voucher from said customer for further calculations or ignore the receipt of said voucher, thus maintaining the customers' privacy since no data concerning the customer's purchasing behavior is documented.

26. The method according to claim 15 comprising further ciphering the voucher sent to said customer before dispensed, and deciphering said voucher using a vender located adjacent to or in said POS before purchase, thus requiring said customer to keep purchasing data stored in the system.

27. The method according to claim 15, comprising further documenting the receipt of said voucher by said customer and storing it in said data warehouse.

28. The method according to claim 15, comprising further encoding a message from the customer, and/or the voucher, thus safeguarding the customers' privacy, and sending said encoded message to a POS apparatus, where the message is decoded and delivered to the customer.

29. The method according to claim 15, wherein said merchandise-related data is selected from a group concerning the volume of said merchandise, weight, firm, brand, expiration date.

30. The method according to claim 15, wherein said vouchers are selected from coupons, tickets, or proofs-of-purchase.

31. The method according to claim 15, comprising further receiving a message from a customer concerning the willing of said customer to purchase at said POS.

32. The method according to claim 15, wherein said analyzing is performed in real-time.

33. The method according to claim 32, wherein the last purchase and the movement direction of said customer are considered in said analyzing.

34. The method according to claim 15, wherein one or more of the previous purchases of said customer taken into considerations before determining the vouchers to be dispensed.

35. The method according to claim 15, wherein said data warehouse further comprises a list of patterns relating to customer's purchasing behavior, said patterns comprising the frequency of specific purchases, enabling the system to dispense vouchers at the appropriate time in order to increase said frequency.

36. A method of doing business by cooperating between various businesses with different or similar interests thus equitably dispensing vouchers of said businesses to customers to increase the total sales in a point of sale (POS), said method comprising:
a. collecting a plurality of vouchers from said businesses;
b. determining which voucher to send according to purchasing behavior stored in an adaptive database; and,
c. dispensing at least one voucher to said customer.

37. The method according to claim 36, wherein said voucher additionally comprises data concerning the type of goods or services, discounts, prices, time limits, expiration dates or any combination thereof.

38. The method according to claim 36, wherein keeping the difference and/or the rate between the number of dispensed vouchers relates to one business and the number of vouchers relates to another business lower than a predetermined threshold so as unfair competition among businesses is avoided.

39. The method according to claim 38, wherein said fairness is provided by normalizing the number of vouchers dispensed in a given time period to one or more customers or POSs, or specific groups of customers, while considering the characteristics of said businesses and merchandise.

40. The method according to claim 36, wherein said POS is selected from a mall, store, business, street, shopping center, regions inside a department store, city, entertainment center or any combination thereof.

41. The method according to claim 36, wherein said step of dispensing is performed when the probability aggregated from said statistical analysis is bigger than a first predetermined threshold and smaller than a second predetermined threshold; said first threshold representing a low likelihood of a customer purchase, and said second threshold representing a high likelihood of a customer purchase.

42. The method according to claim 36 comprising further receiving the customer's decision on whether to document or ignore the receipt of said voucher, thus maintaining the customers' privacy.

43. The method according to claim 36, comprising further documenting the receipt of said voucher by said customer and storing it in said data warehouse.

44. The method according to claim 43, comprising further assuring accurate documentation of purchasing done by said customer while requiring said customer to show said voucher in an apparatus located in or adjacent to said POS before and/or after purchase, such that said documentation obtained is in addition to the businesses documentation.

45. The method according to claim 36, comprising further aggregating data by creating one or more customer profiles, business profiles, purchasing-related profile data, time-related profile, or any combination thereof.

46. The method according to claim 36, comprising further sending said voucher to a point of sale (POS) apparatus, adapted to verify said voucher for the customer and/or business.

47. The method according to claim 36, comprising further providing a vender located in the point of sale (POS) with details of the voucher, sending the voucher code to the system, deciphering the code into the following: cell phone number, date and expiration, a group of vendors, a specific vendor, the code of product or products, benefits and discounts, performing one or more validity checks for example, confirming the validity of the voucher.

48. A system adapted to promote sales for two or more businesses, which communicate with customers using vouchers, comprising:
a. a messaging system, adapted to send said vouchers to said customers and receive replies from said customers;
b. a data warehouse, adapted to store data selected from customers' shopping habits, vouchers, financial data concerning said businesses, discounts, merchandise-related data, or any combination thereof;
c. an active CRM Server, adapted to determine the number and order sent to said customer according to the data stored in said database.

49. The system according to claim 48, comprising further at least one point of sale (POS) vender, adapted to receive a ciphered voucher from said customer upon approaching said POS and decipher said voucher so that said customer can use said voucher, such that purchasing data is documented in the system. (Page 13, last paragraph)

50. The system according to claim 49, wherein said POS vender is further comprised of Deciphered Legitimate Present Unit (DPU) and Code Production Unit (CPU) adapted to decipher the voucher received said customer, thus requiring said customer to use said vender unit in said POS apparatus.

51. The system according to claim 50, wherein the data ciphered and deciphered is selected from a group comprising communication device identifying means, date and expiration, one or more vendors, a specific vendor, the code of product or products, benefits and discounts.

52. The system according to claim 48, comprising further a campaign management application, adapted to identify the need to change voucher dispensing policy and characterize target campaign population, campaign planning and segment customers to be assigned value propositions and/or vouchers.

53. The system according to claim 48, comprising further a registration system, adapted to register and record customer information, selected from a group comprising demographic data and preferences via IVR, filing out forms and/or questionnaires through the internet and/or mobile communications.

54. The system according to claim 48, comprising further means adapted to divide customers into one or more categories and/or groups and/or clubs, so as to easily fit voucher to the correct customers.

55. The system according to claim 54, wherein said means are selected from a group comprising Customer Profile Generator (CPG), Entity Builder Application (EBA), Club Application (CA) or any of the like.

56. The system according to claim 48, comprising further RSG (Rules and Scenario Generator) adapted to enable said businesses to define complex analytical functions comprising triggers, rules, patterns, hypotheses, models, statistical data and more, thus facilitating the system to build a target group of customers and to define sophisticated campaigns.

57. The system according to claim 48, comprising further at least one Reporting Generator (RG) unit, located adjacent to or in said POS, enabling businesses to produce reports and store information concerning purchases and purchases behavior, such that businesses are not authorized to access data relevant to other businesses and privacy is maintained.

58. The system according to claim 48, comprising further means adapted to store data, selected from Detailed Data Storage (DDS), Summaries Data Storage (SDS), Data Mining Statistical Engine (DMSE), adapted to aggregate data, perform statistical analysis and data mining, and perform documentation of the sent vouchers, messages from customer, and the like.
